(19) United States
(12) Patent Application Publication
(10) Pub. No.: US 2014/0329513 A1
(43) Pub. Date: Nov. 6, 2014

(54) PREVENTING CELL PHONE USE WHILE DRIVING

(71) Applicant: CONTINENTAL AUTOMOTIVE SYSTEMS, INC., Auburn Hills, MI (US)

(72) Inventor: Jomon Jacob, Addison, IL (US)

(73) Assignee: Continental Automotive Systems, Inc., Auburn Hills, MI (US)

(21) Appl. No.: 13/875,695

(22) Filed: May 2, 2013

(51) Int. Cl. H04M 1/67; G05B 1/01

(52) U.S. Cl. CPC H04M 1/67; G05B 1/01
USPC 455/418; 340/5.52; 340/5.53

(57) ABSTRACT

A first biometric sensor is configured to obtain a first biometric identifier from the driver of a motor vehicle and provide the driver's biometric identifier to a computer. A second biometric sensor coupled to a cell phone or other wireless communications device enabler/disabler, is configured to obtain a second biometric identifier from a person who attempts to operate the motor vehicle-located wireless communications device. The second biometric identifier is also provided to the same computer. A comparison of the two biometric identifiers enables a determination of whether the driver, or someone else, attempts to use the wireless communications device.

### BACKGROUND

Cellular telephones provide the ability to make and receive telephone calls. They also provide the ability to send and receive text messages. Cell phones have become ubiquitous. Many new motor vehicles are now manufactured with cellular telephones built in, and automobile drivers often bring a cellular phone with them into their car for possible use while driving.

An unfortunate consequence of cell phones' use is that many people use them unwisely. Using a cell phone while driving can lead to serious and even fatal accidents. A method and apparatus that is able to prevent or impede cell phone use, including texting, while driving would be an improvement over the prior art.

### BRIEF SUMMARY

In accordance with embodiments of the invention, a first biometric sensor is configured to obtain a first biometric identifier from the driver of a motor vehicle and provide the driver's biometric identifier to a computer. A second biometric sensor is coupled to a cell phone, or other wireless communications device, enabler/disabler and is configured to obtain a second biometric identifier from a person who attempts to operate the motor vehicle-located wireless communications device. The second biometric identifier is also provided to the same computer. A comparison of the two biometric identifiers enables a determination of whether the driver, or someone else, attempts to use the wireless communications device.

### BRIEF DESCRIPTION OF THE DRAWINGS

FIG. 1 depicts a vehicle dashboard, configured with an apparatus to prevent cell phone use while driving;

FIG. 2 is a side view of the dashboard shown in FIG. 1;

FIG. 3 is a block diagram of an apparatus to prevent cell phone use while driving a motor vehicle; and

FIG. 4 depicts steps of a method of preventing cell phone use while driving.

### DETAILED DESCRIPTION

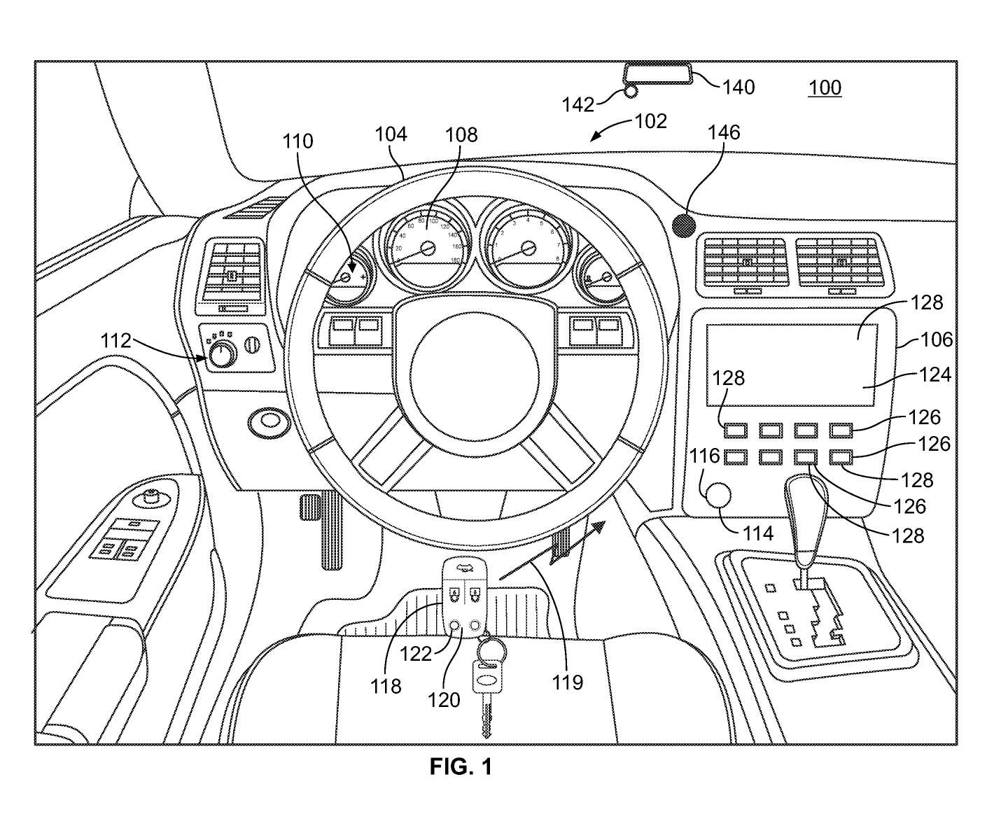

FIG. 1 depicts a vehicle dashboard 100 for a motor vehicle. The dashboard 100 comprises an instrument panel 102 located behind a steering wheel 104. The instrument panel 102 is provided with a user interface 106 for a wireless communications device, not shown, but typically comprising a cellular telephone capable of making and receiving calls, sending and receiving text messages and “browsing” the Internet.

The instrument panel 102 comprises a speedometer 108, various gauges 110 and controls 112. It also comprises a push button ignition switch 114, referred to interchangeably hereafter as an ignition button 114.

The vehicle can be started when a user depresses the ignition button 114.

In a preferred embodiment the ignition button 114 is constructed to include a fingerprint scanner 116, which is able to read grooves and ridges of a person's fingerprint. The finger print scanner 116 generates one or more electrical signals representing grooves and ridges of an individual's fingerprint.

A fingerprint is a biometric identifier. The fingerprint scanner 116 coupled to the ignition button 114 is thus considered to be a biometric sensor. It obtains biometric identifiers embodied as fingerprints. Signals from the fingerprint scanner 116 that represent a biometric identifier/fingerprint are provided to a computer, not shown, which is connected to the fingerprint scanner 116.

A motor vehicle can also be provided with, or configured to operate responsive to a wireless key fob 118. Some embodiments of the key fob 118 are able to lock and unlock vehicle doors by the transmission of radio frequency signals 119 from the key fob 118. Actuating a momentary or push-button switch or ignition button 120 on the fob 118 causes a radio frequency transmitter inside the fob 118 to transmit a signal 119, which will be received by compatible receivers that are within range of the signal transmitted from the key fob 118.

The key fob 118 shown in FIG. 1 differs from prior art key fobs in that it also has an added fingerprint scanner 122 located in front of or on top of the ignition button 120. A fingerprint can be obtained every time the ignition button 120 is depressed or actuated. Actuating the ignition button 120 on the key fob 118 thus causes the finger print scanner 122 to scan or capture a driver's fingerprint, convert the finger print image to signals and transmit the signals 119 representing the fingerprint from the key fob 118 over the radio frequency carrier emitted from the key fob 118 to lock and unlock a vehicle's doors.

Referring again to the dashboard 100, a user interface 106 for a wireless communications device includes a touch sensitive display/input device 124 and several input keys 126. The input keys 126, which can be embodied as touch-sensitive areas or “soft keys” or mechanical switches. One or more of the keys 126 and/or the touch-sensitive display 124 include separate fingerprint scanners 128, each of which is configured to be able to read or scan the ridges and valleys of a fingerprint of a person attempting to use the wireless communications device. This “second” biometric scanner is also able to generate signals representing detected fingerprints.

A conventional rear view mirror 140 allows a driver to see objects behind the vehicle. The mirror 140 supports a camera 142, which is wired to the aforementioned computer and configured to capture a facial image of a person seated behind the steering wheel 104.

A facial image is considered herein to be another type of biometric identifier. The camera thus comprises another biometric sensor. The facial image of a driver captured by the camera 142 can also be provided to a computer as a biometric identifier.

In addition to a fingerprint scanner and a facial image-capturing camera, the dashboard 100 can also include a microphone 146, preferably mounted into the dashboard 102 in a location where the driver's voice can be captured. A person's voice is considered herein to be another type of biometric identifier. The microphone 146, which transduces the audio signals comprising a voice into corresponding electrical signals, is thus another type of biometric sensor, the output of which can also be provided to a computer.

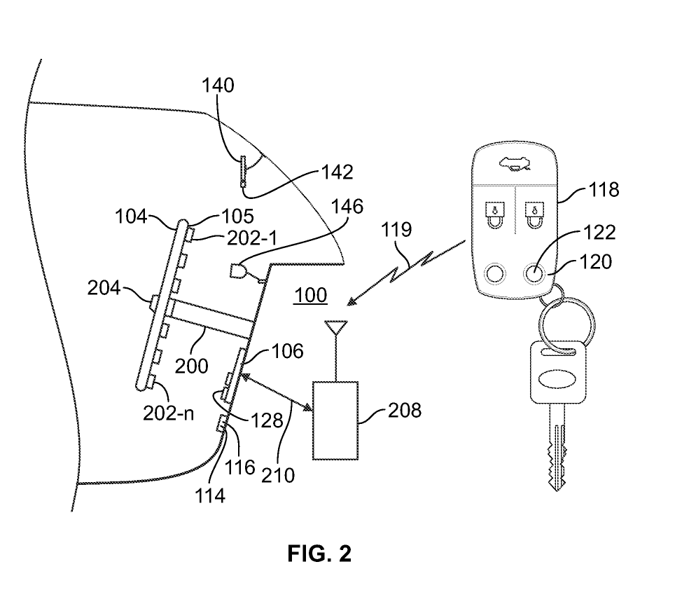

FIG. 2 is a side view of the dashboard 100 shown in FIG. 1. The steering wheel 104 can be seen extending away from the dashboard 100 on a steering column 200. The steering wheel 104 has one or more and preferably several rear-facing fingerprint scanners 202-1-202-n attached to the rear surface 105 of the steering wheel 104. The fingerprint scanners 202-1 through 202-n are schematically represented as being individual fingerprint scanners 200 in order to represent their ability to detect a driver's fingerprints wherever a driver might grasp the steering wheel 104. A steering column-mounted fingerprint scanner 204 is also able to provide one or more signals representative of the ridges and valleys of a person's fingerprint.

The microphone 146 is depicted as projecting outwardly from the front surface of the dashboard 100 toward the steering wheel 104. The camera 142 is depicted as being suspended from the rear-view mirror 140 and directed toward where a driver's face could be read by the camera 142. A cellular telephone 208, which can be mounted in the vehicle's trunk, is shown as being coupled to the dashboard-mounted user interface 106 via a bus 210.

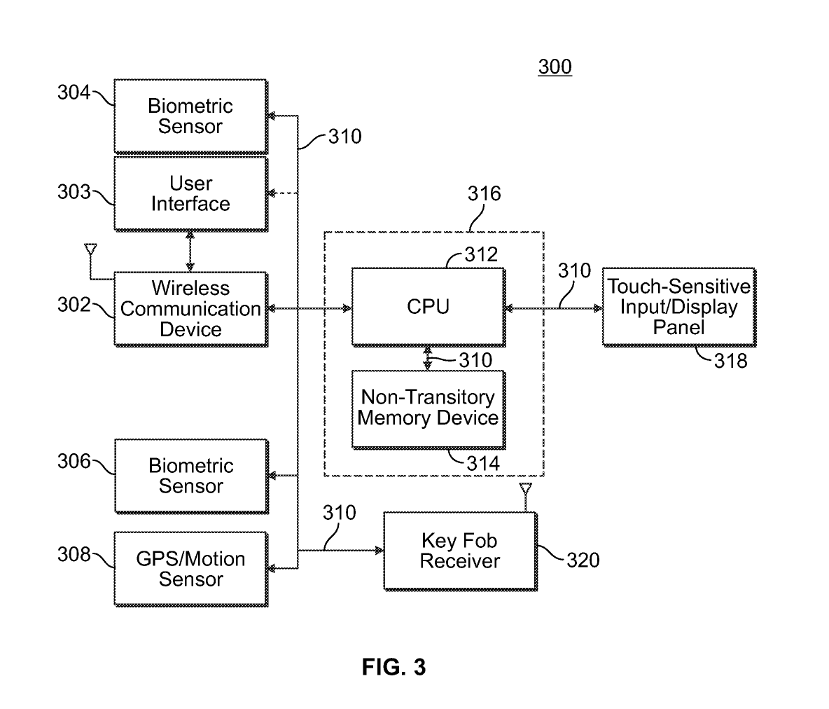

FIG. 3 is a block diagram of an apparatus 300 that impedes or prevents a driver from using a communications device while the driver is operating a motor vehicle that is in motion. The apparatus 300 includes a wireless communications device 302, most commonly implemented as a cellular telephone, coupled to user interface 303 such as the dashboard-mounted user interface 106 depicted in FIG. 1.

The wireless communications device 302 is configured to be able to conduct both voice and data communications. Stated another way, the wireless communications device 302 can take and place phone calls and send and receive text messages and provide web browsing.

The wireless communications device 302 is operatively coupled to a biometric sensor 304, preferably embodied as a fingerprint reader stacked on top of or in front of one or more of the mechanical or electrical switches that comprise the user interface 303, and as described above with respect to FIG. 1.

FIG. 3 depicts another biometric sensor 306, which obtains one or more biometric identifiers from an operator of the motor vehicle. Such identifiers can include a fingerprint, facial scan, retina scan or a voice scan obtained using the aforementioned microphone.

The second biometric scanner 306 is configured to generate output signals corresponding to, or which represent a biometric identifier which the scanner obtained from a driver of the vehicle. In one preferred embodiment the biometric sensor 306 is a fingerprint scanner attached to an ignition button 114, steering wheel 104 or a key fob 118.

A global positioning system/motion sensor 308 is configured to detect whether the vehicle is moving or stationary.

The wireless communications device 302, first biometric sensor 304, user interface 303, second biometric sensor 306 and the GPS/motion sensor 308 are coupled to a central processing unit 312 through a conventional, prior art address/control/data bus 310. The communications device 302, biometric sensors 304, 306 and GPS 208 are thus considered to be “peripheral” devices to the CPU 312.

The bus 310 couples the peripheral devices to the CPU 312 and vice versa. It also enables the CPU to send commands to and receive information from each of the peripheral devices.

The CPU 312 is of course coupled to a non-transitory memory device 314, which stores program instructions executed by the CPU. The memory device 314 also stores data used by the CPU, including data representing fingerprint images. The memory can also store data representing facial scans, data representing retina scans and data representing different voices.

The CPU 312 and memory device 314 are preferably coupled to each other through the same bus 310 that couples the CPU to the various peripheral devices 302, 304, 306 and 308. An optional touch-sensitive input/display panel 318, not shown in FIG. 1 or FIG. 2, enables the CPU 312 to be controlled or interacted with by a user of the motor vehicle.

Together, the CPU 312 and the memory device 314 and the program instructions stored therein comprise a communication device enabler/disabler 316. The enabler/disabler 316 is configured to enable and disable the wireless communications device 302, responsive to comparisons of different biometric identifiers obtained from different biometric sensors 304 and 306 respectively.

In the preferred embodiment, when a user depresses the ignition button 114 as shown in FIG. 1 to start the vehicle, the fingerprint scanner 116 that forms part of the ignition button 114 obtains a fingerprint, which of course uniquely identifies the person depressing the ignition button 114. A first biometric identifier is thus obtained from the biometric sensor embodied as the ignition button-mounted fingerprint scanner.

The system shown in the figures has a default mode of operation, which is to lock or disable the wireless communications device 302, which is under the control of the CPU 312. When a fingerprint is obtained, signals representing the first biometric identifier are sent to the CPU 312 via the bus 310, as shown in FIG. 3.

When a wireless communication is desired, the communications device must of course be operated. When a driver or other occupant of the vehicle can initiate a wireless communication by touching one or more of the control buttons 126 having fingerprint scanners 128, or touches the touch-sensitive screen 124, which also has fingerprint scanners 128, the wireless communications device or its interface 106 will send a corresponding signal to the CPU 312 via the bus 310. A second biometric identifier is thus obtained whenever use of the wireless communications device is attempted.

When the CPU 312 determines that the wireless communications device is being accessed, program instructions in the non-transitory memory device 314 cause the CPU 312 to interrogate the GPS/motion sensor 308 to determine if the vehicle is moving or stationary. If the vehicle is moving, the second biometric identifier obtained from the fingerprint scanner attached to or coupled to the wireless communications device 304 is compared to the first biometric identifier that was obtained when the driver attempted to start the car.

Instructions in the memory device 314 cause the CPU 312 to compare the two biometric identifiers to each other and to determine their relative similarity to each other. If the two biometric identifiers are identical, it can be inferred that the driver is attempting to use the wireless communications device 302 while the vehicle is moving. The wireless communications device 302 is therefore disabled by the CPU 312, for at least as long as the vehicle is in motion or until some other person attempts to operate the wireless communications device 302.

If the two biometric identifiers are dissimilar, it can be inferred that some other occupant of the vehicle, not the driver, is attempting to use the wireless communications device 302. The wireless communications device 302 is therefore enabled by the CPU 312, even if the vehicle is moving.

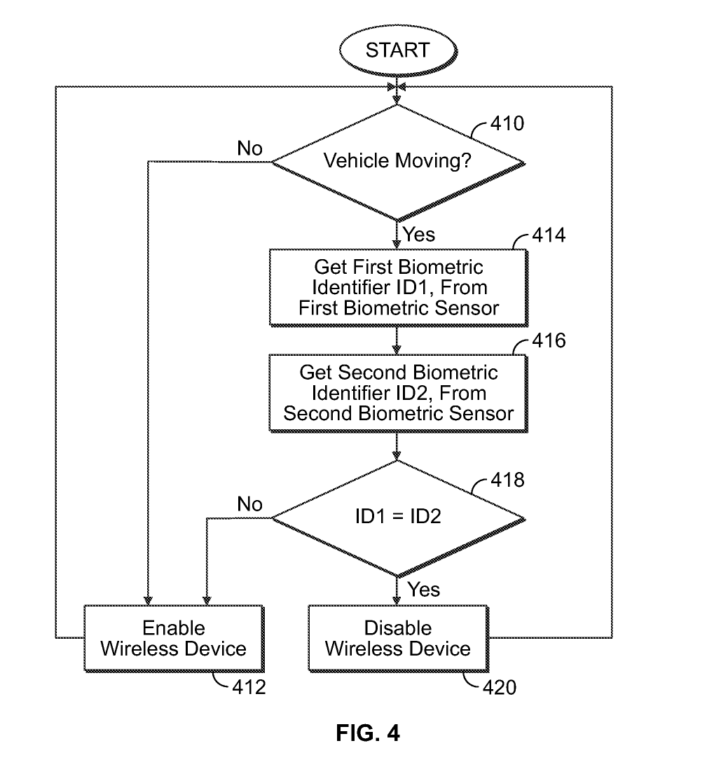

FIG. 4 is a block diagram of the steps of a method 400 for inhibiting a driver's operation of a motor vehicle while the vehicle is moving. As a first step, a determination is made at step 410 whether the vehicle was moving. If not, the wireless device is enabled a step 412. If on the other hand the vehicle is determined to be moving, a biometric identifier is obtained at step 414, preferably from a fingerprint reader but optionally from a facial scanner embodied as the camera 142, a retinal scanner, not shown, or a microphone 146.

After the first biometric identifier, ID1, is obtained at step 414 a second biometric identifier, ID2, is obtained at step 416. The second biometric identifier ID2 is obtained from either a similar or dissimilar biometric sensor.

The biometric identifier obtained from the second biometric sensor can be cross-referenced or correlated to a biometric identifier of a pre-identified individual which is stored in a database and retrievable in order to compare the second biometric identifier ID2 to the first biometric identifier ID 1 obtained from a different type of scanner. By way of example, a facial scan of a driver can be obtained by a camera 142 and stored within the non-transitory memory device 314 and cross-referenced with or correlated to, a particular individual. A fingerprint for that same individual can be obtained from a fingerprint scanner 116 as part of the ignition button 114. Every individual can thus have a unique facial scan and corresponding fingerprint scan, both of which are stored in the memory device 314 and by which the same individual can be identified using two different biometric identifiers.

The two biometric identifiers ID1 and ID2 are compared to each other at step 418. If they are determined to be identical or substantially the same a decision is made that the person attempting to use the wireless communications device is the same person who is driving the car. The results of the comparison in step 418 cause the method to proceed to step 420 where the wireless device is disabled for as long as the driver is operating the vehicle. If on the other hand the two biometric identifiers are different from each other the wireless device is enabled at step 412.

Biometric identifiers can be obtained from a fingerprint scanner as described above. They can also be obtained from a facial scanner or camera. Audio in the form of a person's voice can be analyzed and a numeric representation of it stored within the non-transitory memory device 314. A biometric identifier can also be obtained from a retinal scanner, which might be mounted to the vehicle's visor, not shown, such that it can be swung into and out of position for use by the driver as needed.

The vehicle enabler/disabler 316 described above is preferably embodied as a microprocessor or microcontroller 312, which are conventional devices, well known to have multiple input ports and output ports. The input ports are typically embodied as address, data and control lines configured to receive various types of corresponding signals from biometric sensors such as the biometric scanners 304 and 306. The input ports can also be embodied as inputs to digital to analog converters and/or inputs to analog-to-digital converters.

Those of ordinary skill in the art will know that the outputs from the different biometric scanners are not likely to have identical outputs when reading the same finger from the same individual. Since scanners will inherently have different characteristics themselves the signals the output and which represent a biometric identifier can vary. The method thus evaluates the first biometric identifier and a second biometric identifier to determine a probability that the two identifiers are from the same individual. By way of example, various ridges and valleys of a fingerprint obtained from a first scanner can be obtained to valleys and ridges obtained from a second fingerprint scanner. The number of valleys and ridges that match the output from one scanner to the output from another scanner are compared to each other to determine a probability that the two fingerprints are from one and the same person. The number of comparison points of a fingerprint will of course increase the accuracy of a comparison but will however also increase the time required to make such a determination and also increase the likelihood that a false negative test could result. A probability value is thus selected by the vehicle manufacturer or the operator of the vehicle above or below which a decision is made that the driver and the operator of the communications device are one and the same.

In embodiments where a wireless key fob 118 is provided with a fingerprint scanner 122, the radio frequency signals 119 emitted from the key fob 118 are transmitted to the vehicle where information modulated onto the wireless radio frequency signal is recovered by a key fob receiver 320. The key fob receiver 320 receives radio frequency signals, recovers fingerprint information from the received signals and forwards that information to the CPU 312 via the bus 310.

The apparatus 300 shown in FIG. 3 and as described above is configured to impede or prevent a driver from using a wireless communications device 302 that is built in to a vehicle. In an alternate embodiment, the apparatus 300 is configured to impede or prevent a driver from using a mobile communications device, not built in to the vehicle, but which is pre-configured to be wirelessly controllable by another device, such as the apparatus 300 shown in FIG. 3.

In the alternate embodiment, the apparatus 300 detects radio frequency signals that are routinely and periodically exchanged between mobile communications devices and wireless networks, such detection is made using conventional methods and devices well known in the art.

Upon detecting that a mobile communications device is within the vehicle and operating, by a received signal strength for example, the wireless communications device 302 in the apparatus 300 connects to the in-vehicle mobile communications device using a communication methodology such as the Bluetooth protocol, which is a well-known wireless technology standard used for exchanging data between devices over short distances.

After the wireless communications device 302 and an in-vehicle device are wirelessly connected to each other, a mobile in-vehicle communications device that is configured to be wirelessly controlled by the apparatus 300, is re-configured by the apparatus 300 to be enabled or disabled by the apparatus 300, responsive to biometric identifiers obtained by the sensors 304, 306 as described above. The apparatus 300 shown in FIG. 3 is thus able to prevent mobile cell phones from being used by a vehicle's driver.

Cell phone operation, and/or text messaging, while driving may cause serious and even fatal accidents. The method and apparatus to prevent cell phone use and texting while driving provides an improvement over the prior art.

The foregoing description is for purposes of illustration only. The true scope of the invention is set forth in the claims.

1. An apparatus to impede usage of a communications device while operating a motor vehicle, the apparatus comprising:
a communications device enabler/disabler configured to enable and disable the wireless communications device responsive to a comparison of a first biometric identifier to a second biometric identifier;
a first biometric sensor coupled to the communications device enabler/disabler, the first biometric sensor being configured to obtain the first biometric identifier from an operator of the motor vehicle and to provide to the communications device enabler/disabler a first signal representing the first biometric identifier;
a second biometric sensor coupled to the communications device enabler/disabler, the second biometric sensor being configured to obtain the second biometric identifier from a person who attempts to operate the motor vehicle-located wireless communications device and to provide to the communications device enabler/disabler, a second signal representing the second biometric identifier.

2. The apparatus of claim 1, wherein the motor vehicle-located wireless communications device is a mobile wireless communications device that is not built into the motor vehicle.

3. The apparatus of claim 1, wherein the first biometric sensor comprises a fingerprint scanner.

4. The apparatus of claim 3, wherein the fingerprint scanner comprises part of a vehicle ignition button, the fingerprint scanner being configured to generate a signal representing a fingerprint obtained from operation of the ignition button.

5. The apparatus of claim 4, wherein the ignition button comprises a wireless key fob.

6. The apparatus of claim 3, wherein the motor vehicle includes a steering wheel and the fingerprint scanner comprises part of the steering wheel.

7. The apparatus of claim 1, wherein the motor vehicle includes a steering wheel and wherein the first biometric scanner comprises a face scanner configured to generate a signal representing the face of a person located substantially behind the steering wheel.

8. The apparatus of claim 1, wherein the second biometric scanner is a fingerprint scanner configured to generate a signal representing a finger print obtained from a person attempting to operate the motor vehicle-located wireless communications device.

9. The apparatus of claim 8, wherein the second biometric scanner is a fingerprint scanner coupled to the motor vehicle-located wireless communications device.

10. The apparatus of claim 1, wherein the first biometric scanner is a first voice recognizer, configured to detect the voice of a person operating the motor vehicle and generate a signal representing a biometric identifier of the detected voice.

11. The apparatus of claim 10, wherein the second biometric scanner is the first voice recognizer, configured to detect the voice of a person attempting to operate the motor vehicle-located wireless communications device.

12. The apparatus of claim 1, wherein the first biometric scanner is a retinal scanner.

13. The apparatus of claim 1, wherein the first biometric scanner and the second biometric scanner are different types of scanners and obtain different types of biometric information.

14. The apparatus of claim 1, wherein the vehicle enabler/disabler comprises:
a computer having input ports and output ports, input ports being configured to receive signals from the biometric sensors, an output port being configured to output a communications device-enable/disabling signal to the motor vehicle-located wireless communications device;
a non-transitory memory device coupled to the computer and storing program instructions for the computer, which when executed cause the computer to:
compare the first signal to the second signal;
determine a first probability value that a person attempting to operate the motor vehicle-located wireless communications device is a person operating the motor vehicle responsive to the comparison of the first signal to the second signal; and
if the first probability value is greater than a first threshold probability, output a signal that disables operation of the motor vehicle-located wireless communications device.

15. The apparatus of claim 14, wherein the program instructions cause the computer to:
determine whether the motor vehicle is moving; and,
if the vehicle is not moving, enable operation of the motor-vehicle-located wireless communications device;
if the vehicle is moving, then perform the comparing step, the determining step and, if the first probability is greater than the first threshold probability, output the signal that disables operation of the motor vehicle-located wireless communications device.

16. The apparatus of claim 1, wherein the motor vehicle-located wireless communications device is a wireless telephone device and wherein the communications device enabler/disabler is configured to always enable the motor vehicle-located wireless communications device, responsive to an attempt to call an emergency service provider.

17. A method of impeding a motor vehicle operator's usage of a communications device, the method comprising:
obtaining a first biometric identifier from the motor vehicle operator;
obtaining a second biometric identifier from a person attempting to operate a motor vehicle-located wireless communications device;
comparing the first and second biometric identifiers; and
disabling a motor vehicle-located wireless communications device if the first biometric identifier is substantially the same as the second biometric identifier.

18. The method of claim 17, wherein the motor vehicle-located wireless communications device is a mobile wireless communications device.

19. The method of claim 17, wherein the step of obtaining a first biometric identifier comprises obtaining a signal representing a motor vehicle operator's fingerprint, the signal being obtained from a fingerprint scanner coupled to an ignition switch.

20. The method of claim 19, wherein the ignition switch comprises a wireless key fob.

21. The method of claim 17, wherein the step of obtaining a first biometric identifier comprises obtaining a signal representing a motor vehicle operator's fingerprint, the signal being obtained from a fingerprint scanner coupled to a vehicle steering wheel.

22. The method of claim 17, wherein the step of obtaining a first biometric identifier comprises obtaining a signal representing a motor vehicle operator's face, the signal being obtained from a face scanner.

23. The method of claim 17, wherein the step of obtaining a first biometric identifier comprises obtaining a signal representing a characteristic of a person's voice.

24. The method of claim 17, wherein the step of obtaining a first biometric identifier comprises obtain a signal representing a retina scan.

25. The method of claim 17, wherein the step of disabling the motor vehicle-located wireless communications device if the first biometric identifier is substantially the same as the second biometric identifier is preceded by a step of detecting whether the motor vehicle is moving and wherein the disabling step does not occur if the vehicle is not moving.
